(19) United States
(12) Patent Application Publication
(10) Pub. No.: US 2010/0040787 A1
(43) Pub. Date: Feb. 18, 2010

(54) PROCESS FOR SEALING MICRO PORES OF MICRO-ARC OXIDE FILMS

(75) Inventors: FENG-YUEN DAI, Shindian (TW); CHWAN-HWA CHIANG, Shindian (TW); YUNG-TA LO, Shindian (TW); CHI-CHUANG HO, Shindian (TW); WEI LIU, Shenzhen City (CN); XU-FENG AO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/478,017

(22) Filed: Jun. 4, 2009

(30) Foreign Application Priority Data
Aug. 14, 2008 (CN) 200810303815.1

(51) Int. Cl. B05D 3/02

(52) U.S. Cl. 427/372.2

(57) ABSTRACT

A process for sealing micro pores of micro-arc oxide film is disclosed in the present disclosure. The process may comprise the following steps: providing a metal coated with a micro-arc oxide film; blending a silicone resin and a diluting agent to make a sealing agent; daubing the sealing agent onto the micro-arc oxide film to form a coating on the film's surface.

### CROSS-REFERENCE TO RELATED APPLICATIONS

This application is related to co-pending U.S. patent applications (Attorney Docket Nos. US20819, US23073, and US23075), all entitled “PROCESS FOR SEALING MICRO PORES OF MICRO-ARC OXIDE FILMS”. Such applications have the same assignee as the present application. The above-identified applications are incorporated herein by reference.

### BACKGROUND

1. Technical Field

The present disclosure relates to a process for sealing micro pores of micro-arc oxide films.

2. Description of Related Art

Micro-arc oxidation is a surface treatment process that oxidizes a metal's surface to form a micro-arc oxide film. Micro-arc oxide films have an attractive appearance, like ceramic, and possess high rigidity. Micro-arc oxidation is widely used in the field of surface decoration.

When being treated by micro-arc oxidation at a high temperature, the metal substrate discharges gas through the oxide film formed on the surface, thereby forming a plurality of micro pores in the oxide film. The micro pores should be sealed to prevent the micro-arc oxide film from being contaminated by dirt or other impurity.

A typical process for sealing micro pores of micro-arc oxide film is similar to the process for sealing micro pores of an anode oxide film. However, the micro pores of the micro-arc oxide film are different from those of the anode oxide film in terms of physical dimensions and properties. Therefore, the sealing process for the anode oxide film has poor effect on the micro-arc oxide film. In addition, this sealing process may negatively affect the appearance of the micro-arc oxide film.

Therefore, there is room for improvement within the art.

### DETAILED DESCRIPTION

A process for sealing micro pores of micro-arc oxide films is disclosed in the present disclosure. The process may comprise at least the following steps: providing a piece of metal with micro-arc oxide film thereon; blending a silicone resin with a diluting agent to make a sealing agent; applying the sealing agent onto the micro-arc oxide film to form a coating on the surface of the film. The silicone resin may advantageously be methyl hydrogen silicone fluid. The diluting agent may be organic solvent selected from the group consisting of isopropyl alcohol, toluene, xylene and acetone. The mass ratio between the silicone resin and the organic solvent is about 1˜2:0.5˜1.5. The coating's thickness is about 1˜2 μm.

### Example 1

A piece of aluminum alloy coated with a micro-arc oxide film is provided. The micro-arc oxide film's surface roughness is 1.35 μm. Then, methyl hydrogen silicone fluid and xylene are blended at a mass ratio of 1:1 to make a sealing agent. After that, the sealing process is carried out by uniformly daubing the micro-arc oxide film with the sealing agent. After the daubing step, the aluminum alloy may be placed at room temperature (about 20° C.) for 5˜10 minutes. Meanwhile, some of the sealing agent is adsorbed into the micro pores of the micro-arc film. After the exemplary sealing process, a cleaning process using a dry clean wiper removes the extra sealing agent on the film that was not adsorbed. After the cleaning process, the aluminum alloy may be baked in an oven at about 100° C. for 60 minutes to form a coating on the surface of the micro-arc oxide film. The coating's thickness is 1.2 μm. The surface roughness of the oxide film does not change after being treated by the sealing process. The oxide film's rigidity is 1100 HV The micro-arc oxide film can pass smudge resistance testing after being treated by the sealing process.

### Example 2

A piece of aluminum alloy coated with a micro-arc oxide film is provided. The micro-arc oxide film's surface roughness is 1.35 μm. Then, methyl hydrogen silicone fluid and xylene are blended at a mass ratio of 2:1 to make a sealing agent. After that, the sealing process is carried out by uniformly daubing the micro-arc oxide film with the sealing agent. After the daubing step, the aluminum alloy may be placed at room temperature (about 20° C.) for 5˜10 minutes. Meanwhile, some of the sealing agent is adsorbed into the micro pores of the micro-arc film. After the exemplary sealing process, a cleaning process using a dry clean wiper removes the extra sealing agent on the film that was not adsorbed. After the cleaning process, the aluminum alloy may be baked in an oven at about 100° C. for 60 minutes to form a coating on the surface of the micro-arc oxide film. The coating's thickness is 1.5 μm. The surface roughness of the oxide film does not change after being treated by the sealing process. The oxide film's rigidity is 1050 HV The micro-arc oxide film can pass smudge resistance testing after being treated by the sealing process.

The process of sealing micro pores is fit for the micro-arc oxide film which is formed on aluminum alloy, magnesium alloy and titanium alloy.

The process of sealing micro pores of micro-arc oxide film will not affect the rigidity and the appearance of the film. It is appropriate for sealing micro pores of micro-arc oxide film.

It should be understood, however, that even though numerous characteristics and advantages of the present embodiments have been set forth in the foregoing description, together with details of functions of the embodiments, the disclosure is illustrative only, and changes may be made in detail, especially in matters of mass ratio of the sealing agent and laying or baking time within the principles of the invention to the full extent indicated by the broad general meaning of the terms in which the appended claims are expressed.

What is claimed is:

1. A process for sealing micro pores of micro-arc oxide films comprising:
providing a metal having a micro-arc oxide film;
blending a silicone resin and a diluting agent to make a sealing agent;
applying the sealing agent onto the micro-arc oxide film to form a coating on the film's surface.

2. The process as claimed in claim 1, wherein the step of blending silicone resin further comprises blending methyl hydrogen silicone fluid.

3. The process as claimed in claim 2, wherein the step of blending diluting agent further comprises blending an organic solvent selected from the group consisting of isopropyl alcohol, toluene, xylene, and acetone.

4. The process as claimed in claim 3, wherein the mass ratio between the methyl hydrogen silicone fluid and organic solvent is 1˜2:0.5˜1.5.

5. The process as claimed in claim 1, wherein the thickness of the coating is 1˜2 μm.

6. The process as claimed in claim 1, wherein the metal is selected from the group consisting of aluminum alloys, magnesium alloys and titanium alloys.
